(19) United States
(12) Patent Application Publication
(10) Pub. No.: US 2002/0138614 A1
(43) Pub. Date: Sep. 26, 2002

(54) Method and apparatus to manage network addresses

(76) Inventor: Dennis W. Hall, Toronto (CA)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/813,416

(22) Filed: Mar. 20, 2001

(51) Int. Cl. G06F 15/173; G06F 15/16

(52) U.S. Cl. 709/225; 709/202

(57) ABSTRACT

A method and apparatus to manage use of a network address is described.

### BACKGROUND

A network typically comprises a plurality of network nodes connected together by a communications medium. A network node may comprise, for example, a switch, router, personal computer, server, network appliance or any other network device. Each network node is typically assigned a unique network address. The network address ray be used, for example, to route information between individual nodes.

A network address may be either permanent or temporary. The latter may occur whenever a node is not permanently connected to a particular network. For example, a personal computer may attempt to establish a temporary connection with a private network. Since the connection is temporary, the personal computer may be assigned a temporary network address that may last for the duration of the temporary connection. This process is sometimes referred to as the dynamic assignment of network addresses.

There may be a number of problems associated with the dynamic assignment of network addresses. For example, the assignment process may require a particular protocol that is unknown to the network node seeking assignment. A protocol may refer to a set of procedures by which two network nodes communicate information. In addition, the temporary assignment may expire prior to the network node disconnecting from the network. Therefore, each network node may need to manage the assignment, such as requesting extensions of time to the original assignment, or a re-assignment, on a periodic basis.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention.

FIG. 2 is a block diagram of a system in accordance with one embodiment of the invention.

FIG. 3 is a first block flow diagram of the programming logic performed by a client proxy module in accordance with one embodiment of the invention.

FIG. 4 is a second block flow diagram of the programming logic performed by a client proxy module in accordance with one embodiment of the invention.

FIG. 5 is a third block flow diagram of the programming logic performed by a client proxy module in accordance with one embodiment of the invention.

FIG. 6 illustrates a message flow for a DHCP address assignment in accordance with one embodiment of the invention.

### DETAILED DESCRIPTION

In the following detailed description, numerous specific details are set forth in order to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention.

The embodiments of the invention comprise a method and apparatus to manage the dynamic assignment of network addresses. One embodiment of the invention comprises a client proxy that resides on a device providing access to a network. Such a device may be referred to herein as a network gateway. The client proxy is capable of receiving a request for assignment of a network address from a client, procuring the network address on behalf of the client from a network address provider, and managing use of the network address for the client. In addition, the client proxy may perform this function on behalf of multiple clients, thereby reducing the need for individual clients to understand and implement the assignment process. The term “client” as used herein may refer to any network node requesting assignment of a network address. The term “network address provider” as used herein may refer to any network node providing assignment of a network address.

There are several advantages associated with using a client proxy. For example, the client may be unaware of the protocol used to dynamically assign the network address. The client proxy may procure a network address on behalf of a client using the proper protocol without having to configure each client individually. Further, the network address assignment may be temporary, and therefore the client may need to periodically request extensions of time to renew use of the network address. The client proxy may undertake this task on behalf of the client, thereby conserving client resources for other uses. In addition, modifications to the address assignment process may be implemented at the client proxy rather than at each individual client.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

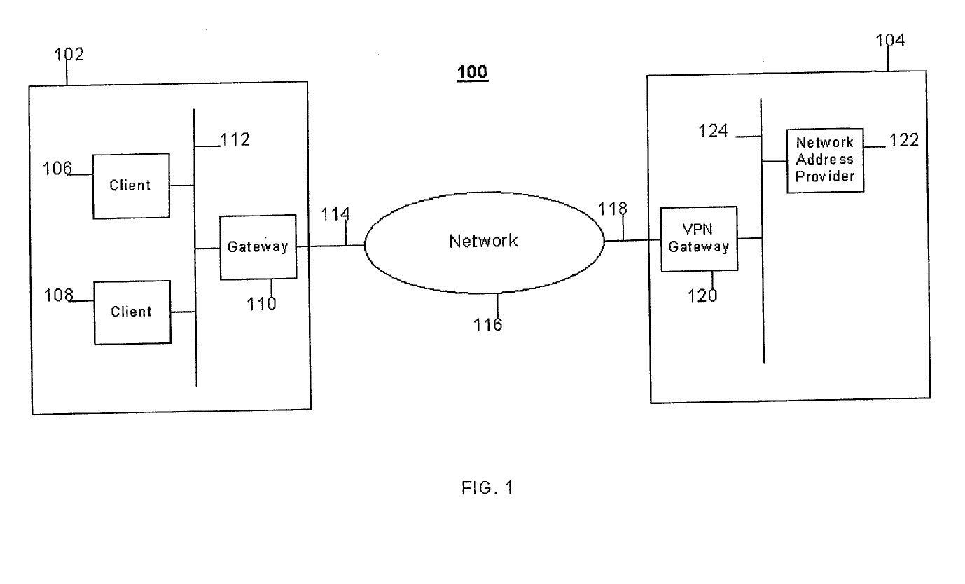

Referring now in detail to the drawings wherein like parts are designated by like reference numerals throughout, there is illustrated in FIG. 1 a system suitable for practicing one embodiment of the invention. FIG. 1 is a block diagram of a network 100. Network 100 may comprise a network 102, a network 116 and a network 104. In one embodiment of the invention, networks 102 and 104 may be local area networks (LANs) or wide area networks (WANs), although the embodiments of the invention are not limited in this context.

In one embodiment of the invention, network 102 may comprise a client 106, a client 108, and a gateway 110, all capable of communicating information over a communication links 112. Clients 106 and 108 may comprise, for example, personal computers. Gateway 110 may comprise a network node capable of connecting clients 106 and 108 with network 116 over communications link 114.

Networks 102 and 104 may communicate information with network 116 over communication links 114 and 118, respectively. In one embodiment of the invention, network 116 may comprise a plurality of network nodes (not shown) communicating in accordance with one or more Internet protocols, such as the Transmission Control Protocol (TCP) as defined by the Internet Engineering Task Force (IETF) standard 7, Request For Comment (RFC) 793, adopted in September, 1981, and the Internet Protocol (IP) as defined by the IETF standard 5, RFC 791, adopted in September, 1981, both available from “www.ietf.org” (“TCP/IP Specification”).

In one embodiment of the invention, network 104 may comprise a Virtual Private Network (VPN). A VPN may comprise a plurality of network nodes connected by a physical communications medium, with each network node capable of communicating information with other network nodes over one or more secure virtual connections. A virtual connection as used herein may refer to a logical connection that may utilize a portion of the available bandwidth provided by the physical communications medium. The term “bandwidth” as used herein may refer to the speed at which information may be communicated between network nodes, which is typically measured in bits-per-second (bps). The term “secure” as used herein may refer to communicating information in accordance with a security scheme or technique. In one embodiment of the invention, VPN network 104 comprises a VPN gateway 120 and a network address provider 122, both capable of communicating information over a communications link 124.

In one embodiment of the invention, VPN gateway 120 may comprise a network node that provides secure access to VPN network 104. For a network node to have access to VPN network 104, the network node must establish a secure virtual connection to VPN network 104 through VPN gateway 120. The virtual connection may be made secure through use of one or more security schemes, such as a symmetric scheme in accordance with the Data Encryption Standard (DES) or Triple DES (TDES) as defined by the National Institute of Standards and Technology, Federal Information Processing Standards Publication 46-3, Oct. 25, 1995, and available from “http://csrc.nist.gov/cryptval/des/desval.html” (“DES Specification”), a Secure Hypertext Transfer Protocol (S-HTTP) as defined by the IETF experimental standard RFC 2660, August 1999 (“S-HTTP Specification), or an asymmetric scheme in accordance with the Secure Sockets Layer (SSL) Protocol Version 3.0 Internet draft as defined by the IETF, November 1996 (“SSL Specification”), or the Transport Layer Security (TLS) Protocol draft standard as defined by the IETF RFC 2246, January 1999 (“TLS Specification), all three of which may be available from “www.ietf.org,” although the embodiments of the invention are not limited in this context.

In one embodiment of the invention, network address provider 122 may comprise a server capable of assigning a network address to a potential client in accordance with one or more address assignment schemes. In one embodiment of the invention, network address provider 122 may be configured to assign an IP network address in accordance with the Dynamic Host Configuration Protocol (DHCP) draft standard as defined by the IETF RFC 1541, October 1993, available from “www.ietf.org” (“DHCP Specification”).

The DHCP Specification provides for the allocation of a temporary or permanent network IP address to a client. The client may request the use of an address for some time period. The allocation mechanism may include one or more DHCP servers that agree to not reallocate that network address within the requested time and may attempt to return the same network address each time the client requests an address, if possible. The period over which a network address is allocated to a client may be referred to herein as a “lease period.” The client may extend its lease with subsequent requests. The client may issue a message to release the address back to the server when the client no longer needs the address. The client may ask for a permanent assignment by asking for an infinite lease. Even when performing a permanent assignment, the DHCP server may choose to give a lengthy but finite lease to allow detection in the case a client has been retired or placed out-of-service.

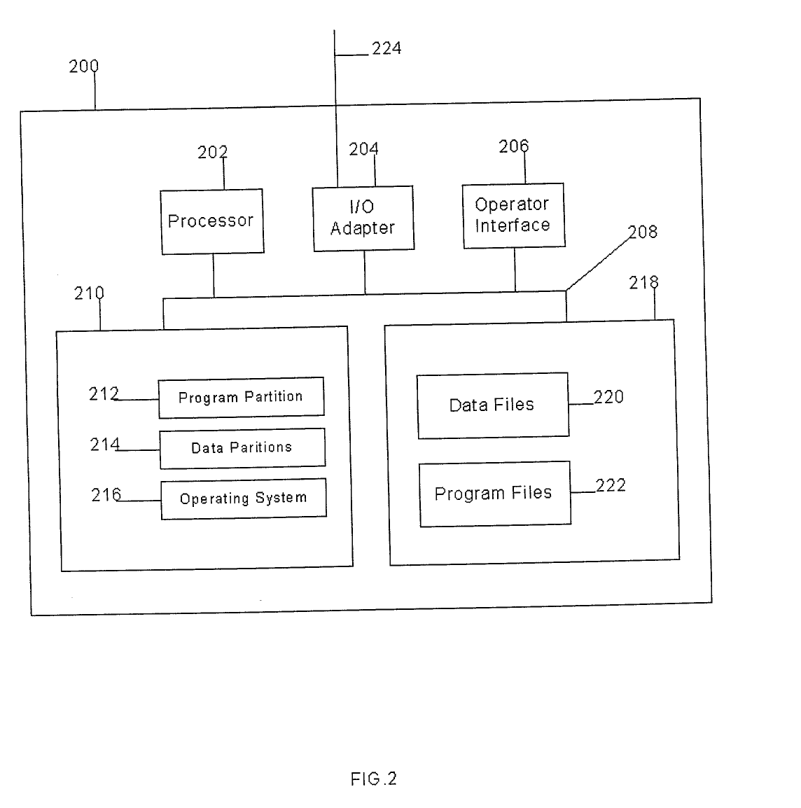

FIG. 2 is a block diagram of a system 200 in accordance with one embodiment of the invention. System 200 may be representative of a network node, such as VPN gateway 120, for example. As shown in FIG. 2, system 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, lisp and assembly. Processor 202 executes the program instructions, and processes the data, stored in memory 210. Disk storage 218 stores data to be transferred to and from memory 210. adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. I/O adapter 204 represents one or more I/O adapters or network interfaces that can connect to local or wide area networks such as, for example, the networks described in FIG. 1. Therefore, connection 224 represents a network or a direct connection to other equipment.

As shown in FIG. 2, system 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++ and assembly. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. 1/0 adapter 204 represents one or more 1/0 adapters or network interfaces that can connect to local or wide area networks such as, for example, one or more networks described in FIG. 1. Therefore, connection 224 represents a network or a direct connection to other equipment.

Processor 202 can be any type of processor capable of providing the speed and functionality required by the embodiments of the invention. For example, processor 202 could be a processor from family of processors made by Intel Corporation, Motorola Incorporated, Sun Microsystems Incorporated, Compaq Computer Corporation and others. Processor 202 may also comprise a digital signal processor (DSP) and accompanying architecture, such as a DSP from Texas Instruments Incorporated.

In one embodiment of the invention, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (eg., floppy disk and hard drive), optical disk (e.g., CD-ROM) and any other media that may store digital information. In one embodiment of the invention, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, client 200 may contain various combinations of machine-readable storage devices through various I/O controllers, which are accessible by processor 202 and which are capable of storing a combination of computer program instructions and data.

Memory 210 is accessible by processor 202 over bus 208 and includes an operating system 216, a program partition 212 and a data partition 214. In one embodiment of the invention, operating system 216 may comprise an operating system sold by Microsoft Corporation, such as Microsoft Windows” 95, 98, 2000 and NT, for example. Program partition 212 stores and allows execution by processor 202 of program instructions that implement the functions of each respective system described herein. Data partition 214 is accessible by processor 202 and stores data used during the execution of program instructions.

In one embodiment of the invention, program partition 212 contains program instructions that will be collectively referred to herein as a client proxy module. This module may perform the functions of procuring a network address for a client, and managing use of the network address by the client. Of course, the scope of the invention is not limited to the particular set of instructions described herein.

I/O adapter 204 may comprise a network adapter or network interface card (NIC) configured to operate with any suitable technique for controlling communication signals between computer or network devices using a desired set of communications protocols, services and operating procedures, for example. In one embodiment of the invention, I/O adapter 204 may operate, for example, in accordance with the TCP/IP Specification. Although I/O adapter 204 may operate with in accordance with the above described protocol, it can be appreciated that I/O adapter 204 may operate with any suitable technique for controlling communication signals between computer or network devices using a desired set of communications protocols, services and operating procedures, for example, and still fall within the scope of the invention. I/O adapter 204 may also include appropriate connectors for connecting I/O adapter 204 with a suitable communications medium. I/O adapter 204 may receive communication signals over any suitable medium such as copper leads, twisted-pair wire, co-axial cable, fiber optics, radio frequencies, and so forth.

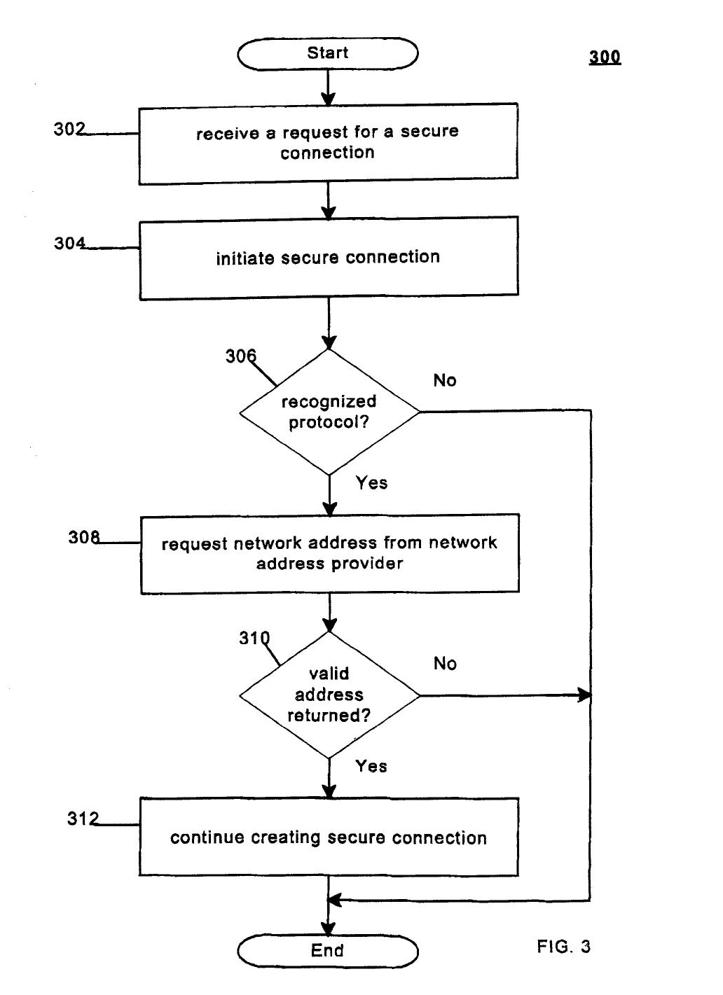

The operations of systems 100 and 200 may be further described with reference to FIGS. 3, 4 and 5, and accompanying examples. Although FIGS. 3, 4 and 5 presented herein may include a particular processing logic, it can be appreciated that the processing logic merely provides an example of how the general functionality described herein can be implemented. Further, each operation within a given processing logic does not necessarily have to be executed in the order presented unless otherwise indicated.

FIG. 3 is a first block flow diagram of the programming logic performed by a client proxy module in accordance with one embodiment of the invention. The term “client proxy module” refers to the software and/or hardware used to implement the functionality for procuring a network address for a client and managing the use thereof, as described herein. In this embodiment of the invention, this function is performed by VPN gateway 120. It can be appreciated that his functionality, however, can be implemented by any device, or combination of devices, located anywhere in a communication network and still fall within the scope of the invention.

FIG. 3 illustrates a process 300 that when executed by a processor, such as processor 202, performs the programming logic described therein. As shown in FIG. 3, a request for a secure connection is received at block 302. A process for creating a secure connection is initiated at block 304. A determination is made as to whether a recognized protocol is making the request for a secure connection at block 306. If the protocol does not comprise a recognized protocol, the processing logic ends. If the protocol comprises a recognized protocol, however, a network address is requested from a network address provider at block 308. A determination is made as to whether a valid network address has been returned at block 310. If there was no valid network address returned, the processing logic ends. If a valid network address is returned, however, the process for creating a secure connection continues at block 312. Process 300 then ends.

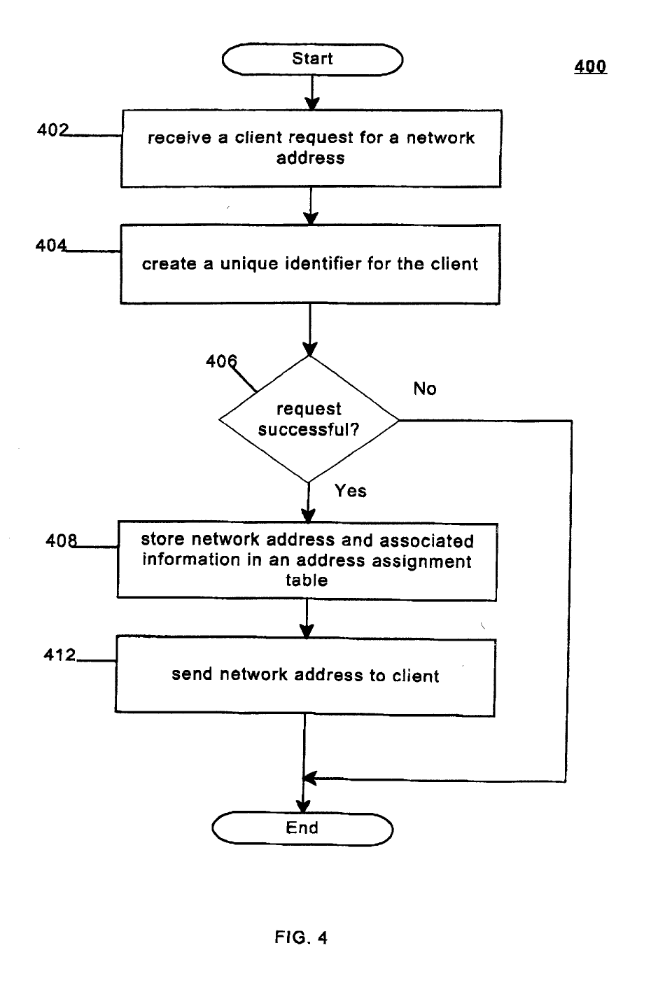

FIG. 4 is a second block flow diagram of the programming logic performed by a client proxy module in accordance with one embodiment of the invention. FIG. 4 illustrates a process 400 that may be representative of the processing logic illustrated in block 308. As shown in process 400, a client request for a network address is received at block 402. A unique identifier is created for the client at block 404. A determination is made as to whether the client request is successful at block 406. If the client request is not successful, the processing logic ends. If the client request is successful, however, a network address and associated information is stored in an address assignment table at block 408. The network address is sent to the client at block 412. Process 400 then ends.

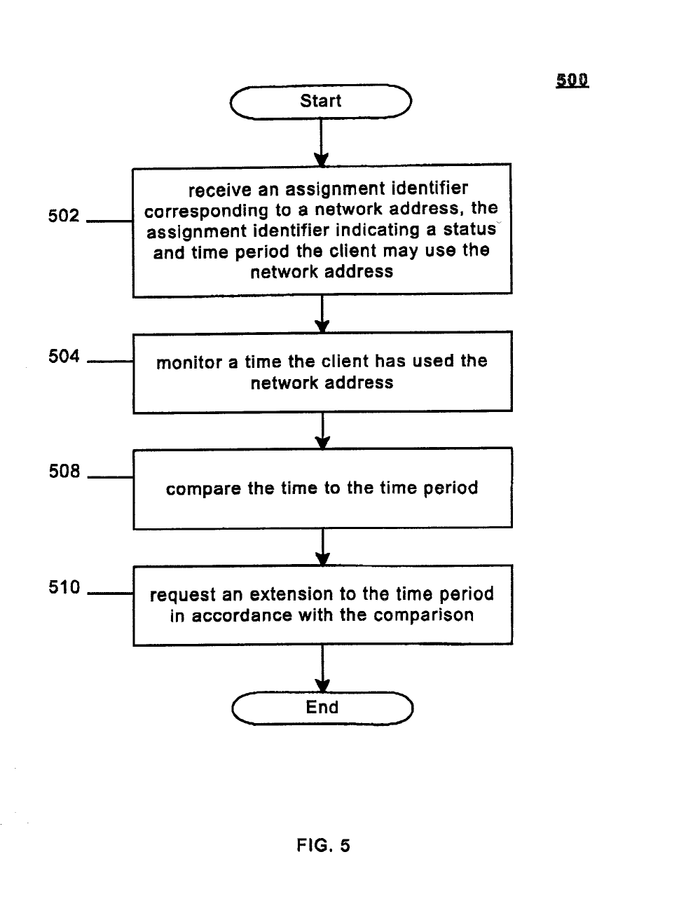

FIG. 5 is a third block flow diagram of the programming logic performed by a client proxy module in accordance with one embodiment of the invention. FIG. 5 illustrates a process 500. In process 500, an assignment identifier is received at block 502. The assignment identifier may correspond to a network address, and may indicate a status and time period the client may use the network address. A time the client has used the network address is monitored at block 504. The time is compared to a time period at block 508. A request for an extension of time to the time period is made at block 510 in accordance with the results of the comparison made at block 508. Process 500 then ends.

The operation of systems 100, 200 and the flow diagrams shown in FIGS. 3, 4 and 5, may be better understood by way of example. In this example, a client such as client 106 or 108 seeks to connect to VPN network 104. Client 106 may initiate a connection to network 116 through gateway 110. Client 106 may send a request for a secure connection to VPN network 104 over network 116. The request may be received by VPN gateway 120. VPN gateway 120 recognizes the request for a secure connection and begins executing a process for creating a secure connection in accordance with a desired security scheme, such as a security scheme as set forth in the DES Specification. Part of the process of creating the secure connection comprises having a network address recognized by VPN network 104 assigned to client 106. The network address may be, for example, an IP address. VPN gateway 120 initiates execution of processing logic 300 for the client proxy module residing in program partition 212 using processor 202 of VPN gateway 120.

The client proxy module is configured to request an assignment of an IP address from a network address provider in accordance with a network address assignment protocol. An example of a network address assignment protocol may include a protocol as set forth in the DHCP Specification. The client proxy module would first determine whether the request sent from client 106 was in a protocol recognized by the client proxy. One example of a recognized protocol might be the Layer Two Tunneling Protocol (L2TP) as defined by the ETF Proposed Standard RFC 2661, August 1999 (“L2TP Specification”), available from “www.ietf.org” (“L2TP Specification”). If the request from client 106 is in the form of a recognized protocol, the client proxy would procure a network address for the client from a DHCP server, such as network address provider 122, in accordance with the DHCP Specification. If a valid network IP address is received from the DHCP server, the assigned network IP address is used to complete the secure virtual connection. If a valid network address is not received from the DHCP server within a certain time period, the client proxy could resend the request a predetermined number of times. At the end of the predetermined number of attempts a valid IP address is not received from the DHCP server, the client proxy could send a message to the client indicating that attempts to create a secure virtual connection to VPN network 104 has failed.

The client proxy provides functionality to perform a part of the overall process to create a secure virtual connection. More particularly, the client proxy performs to procure a network address on behalf of a client. This may be particularly useful, for example, if the client is unaware of the protocol for requesting assignment of a network address for a particular private network, such as VPN network 104. In this manner, a single client proxy may be configured to receive requests for secure virtual connections that may be communicated using any number of recognized protocols that may differ from the assignment protocol used by a particular private network, thereby reducing functional redundancy. In one embodiment of the invention, the client proxy may receive a request for a network address sent in a format as set forth in the L2TP Specification. The client proxy may create a unique identifier for the client. The client proxy may then formulate the appropriate DHCP request for assignment of a dynamic IP address using the unique identifier, and send it to the DHCP server. The unique identifier allows the client proxy to maintain records of the address assignment process for multiple clients and at multiple stages of each request. The client proxy determines whether the DHCP request returned a valid IP address, and if so, stores the assigned IP address with the unique identifier in memory, such as an address assignment table. The client may then return the procured IP address to the client.

In addition to the requested IP address, the client proxy may also receive other information associated with the IP address. For example, the client proxy may receive an assignment identifier with the IP address. The assignment identifier may comprise, for example, a status and one or more time periods. The status may indicate whether the assignment is a temporary or permanent assignment of the network address. If the status indicates a temporary assignment, the time period(s) may indicate how long the client may be authorized to use the assigned IP address. In the case of a permanent assignment, the time period may be set to a default value, minus one, for example.

Once the client proxy receives the assigned IP address and address identifier, both may be stored in the address assignment table. The client proxy may monitor a time the client uses the IP address. The monitored time is compared to the lease period the client may use the assigned IP address. At certain time intervals prior to the expiration of the lease period, the client proxy may perform certain operations to manage use of the assigned IP address. For example, the DHCP server may return three interval time periods for the client to renew, rebind and expire the temporary assignment of the IP address. If the DHCP server does not return these three interval time periods, the client proxy may use substitute default values. In one embodiment of the invention, the interval time periods may be 50% of the lease period, 87.5% of the lease period, and 100% of the lease period, for example. The client proxy may set and monitor a timer associated with each assignment of an IP address. The client proxy would then initiate certain actions at the interval time periods. Using the default values, for example, the client proxy would automatically send a request to renew the lease period to the DHCP server once 50% of the lease period had passed. The term “automatically” as used herein refers to an action that may occur without direct human intervention. If the client proxy fails to receive a message from the DHCP server indicating the lease period has been renewed, the client proxy may resend the request a predetermined number of times. If the client proxy fails to receive a renewal message after all the attempts have been exhausted, the client proxy may wait until the next interval time period to send a rebind request to the DHCP server. If this also fails after a certain number of attempts, the client proxy may attempt to procure additional time to the lease period at expiration of the lease period. Should any of these attempts prove successful the client can continue to use the assigned IP address and all of the timers may be extended to cover the new lease period. Of course, the client proxy may not need to perform these management functions if the client received a permanent lease from the DHCP server.

In one embodiment of the invention, there may be separate processes to manage each client's IP address renewal. In another embodiment of the invention, all the leases may be placed in a single list where entries are stored by ascending renewal times, for example. When the client proxy finds entries in the lease list it will only process the leases that are either due to expire within a certain predetermined time period of the current time, or that have already expired. For example, the certain predetermined time period might be twenty (20) seconds.

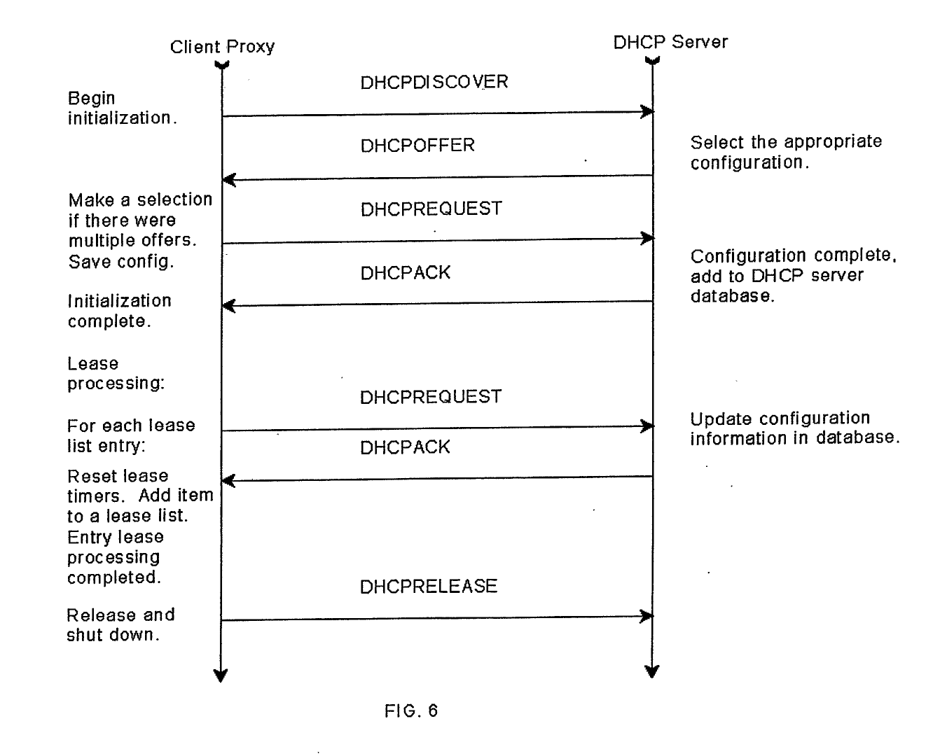

FIG. 6 illustrates a message flow for a DHCP address assignment in accordance with one embodiment of the invention. As shown in FIG. 6, the client proxy may send a DHCPDISCOVER message on its local physical subnet. The DHCPDISCOVER message may include options that suggest values for the network address and lease duration. One or more DHCP servers may respond with a DHCPOFFER message that includes an available network address and configuration parameters for the DHCP server. The client may select the DHCP server and network address by sending a DHCPREQUEST message to the selected DHCP server using the received configuration parameters. The selected DHCP server may commit the binding for the client to persistent storage and may respond with a DHCPACK message containing the configuration parameters for the client. The client may receive the DHCPACK message and performs a final check on the configuration parameters, and notes the duration of the lease and a lease identification “cookie” specified in the DHCPACK message. At this point the client may be configured to use the assigned network address.

The client proxy may attempt to extend the lease for each client by sending a DHCPREQUEST message indicating the client would like to extend its lease. The DHCP server will determine whether this is acceptable, and if so, update its configuration information for the client and send back a DHCPACK message to the client proxy. The client proxy may then reset its lease timers and update its address assignment table with the appropriate information.

The client may choose to relinquish its lease on a network address by sending a message to the client proxy, and the client proxy may then send a DHCPRELEASE message to the DHCP server. The client proxy may identify the lease to be released using the client's unique identifier.

To manage communication attempts between the client proxy and DHCP server, the client proxy may also set a timer when a message is sent to the DHCP server. If there is no reply from the DHCP server within a certain time period (e.g., a few seconds), the client proxy may be notified and may take appropriate action. Appropriate action may include resetting the timer value, incrementing a retry count if it is below the maximum and sending another request message, or notifying the client of a failure if the maximum retry count has been reached. Instead of having to cope with many active timers in the system, the timers may be added to a timer object list where only the timer with the largest value is processed. If more than one client has a timer that will expire at the same time they may be processed at the same time.

It can be appreciated that the term “timer” as used herein may comprise a software timer comprising a set of computer program instructions executed by a processor, such as processor 202, and stored in program partition 212, or a hardware timing circuit (not shown) that is part of VPN gateway 120.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to manage network addresses, comprising:
receiving a first request for a network address from a client at an agent;
procuring said network address from a network address provider; and
sending said network address to said client.

2. The method of claim 1, wherein said first request is received using a first protocol, and said procuring comprises:
creating a second request for said network address using a second protocol;
sending said second request to a network address provider;
receiving said network address from said network address provider; and
storing said network address in an address assignment table.

3. The method of claim 2, wherein said creating comprises:
assigning a unique identifier to said client; and
creating said second request using said unique identifier.

4. The method of claim 1, further comprising managing use of said network address by said client.

5. The method of claim 4, wherein said managing comprises:
receiving an assignment identifier corresponding to said network address, said assignment identifier indicating a status and time period said client may use said network address;
monitoring a time said client has used said network address;
comparing said time to said time period; and
requesting an extension to said time period in accordance with said comparison.

6. The method of claim 1, wherein said network address provider is a dynamic host configuration protocol server.

7. The method of claim 1, wherein said network address comprises an Internet Protocol address.

8. The method of claim 2, wherein said first protocol is a layer two tunneling protocol.

9. The method of claim 2, wherein said second protocol is a transport control protocol and internet protocol.

10. A method to create a virtual connection to a network, comprising:
receiving a message from a client requesting a virtual connection;
sending a request for assignment of a network address for said client;
receiving said network address; and
creating said virtual connection using said network address.

11. The method of claim 10, wherein said creating comprises creating said virtual connection using said network address in accordance with a security scheme.

12. The method of claim 11, wherein said security scheme is a security scheme in accordance with the DES Specification.

13. An article comprising:
a storage medium;
said storage medium including stored instructions that, when executed by a processor, result in receiving a first request for a network address from a client at an agent, procuring said network address from a network address provider, and sending said network address to said client.

14. The article of claim 13, wherein the stored instructions, when executed by a processor, further result in receiving said request using a first protocol, and said procuring results in creating a second request for said network address using a second protocol, sending said second request to a network address provider, receiving said network address from said network address provider, and storing said network address in an address assignment table.

15. The article of claim 14, wherein the stored instructions, when executed by a processor, further result in creating a second request by assigning a unique identifier to said client, and creating said second request using said unique identifier.

16. The article of claim 13, wherein the stored instructions, when executed by a processor, further result in managing use of said network address by said client.

17. The article of claim 16, wherein the stored instructions, when executed by a processor, further result in managing use of said network address by receiving an assignment identifier corresponding to said network address, said assignment identifier indicating a status and time period said client may use said network address, and monitoring a time said client has used said network address, comparing said time to said time period, and requesting an extension to said time period in accordance with said comparison.

18. An article comprising:
a storage medium;
said storage medium including stored instructions that, when executed by a processor, result in creating a virtual connection to a network by receiving a message from a client requesting a virtual connection, sending a request for assignment of a network address for said client, receiving said network address, and creating said virtual connection using said network address.

19. The article of claim 18, wherein the stored instructions, when executed by a processor, further result in creating said virtual connection in accordance with a security scheme.

20. The article of claim 18, wherein the stored instructions, when executed by a processor, further result in creating said virtual connection in accordance with the DES Specification.
